(19) United States
(12) Patent Application Publication
(10) Pub. No.: US 2025/0117309 A1
(43) Pub. Date: Apr. 10, 2025

(54) METHOD FOR DETECTING A MEMORY ACCESS ERROR IN A MULTI-THREADED APPLICATION

(71) Applicant: Robert Bosch GmbH, Stuttgart (DE)

(72) Inventors: Arne Hamann, Ludwigsburg (DE); Anthony Rowe, Pittsburgh, PA (US); Arjun Ramesh, Pittsburgh, PA (US); Dirk Ziegenbein, Freiberg Am Neckar (DE); Emily Ruppel, Pittsburgh, PA (US); Jaspreet Riar, Pittsburgh, PA (US); Michael Pressler, Karlsruhe (DE); Nuno Pereira, Pittsburgh, PA (US); Tianshu Huang, Pittsburgh, PA (US)

(21) Appl. No.: 18/892,635

(22) Filed: Sep. 23, 2024

(30) Foreign Application Priority Data
Oct. 9, 2023 (DE) 10 2023 209 823.7

(51) Int. Cl. G06F 11/36

(52) U.S. Cl. CPC G06F 11/3604; G06F 11/3624; G06F 11/3636

(57) ABSTRACT

A method for detecting a memory access error in a multi-threaded application. The method includes: converting the multi-threaded application to a bytecode representation thereof; profiling the bytecode representation to determine at least one shared memory access point by at least two threads of the bytecode representation; injecting a delay time frame into a respective memory access operation to the shared memory access point by at least one thread of the at least two threads; monitoring accesses of the at least two threads to the shared memory access point during the delay time frame to detect the memory access error. A computer program, an apparatus, and a storage medium are also described.

### CROSS REFERENCE

The present application claims the benefit under 35 U.S.C. § 119 of German Patent Application No. DE 10 2023 209 823.7 filed on Oct. 9, 2023, which is expressly incorporated herein without reference in its entirety.

### FIELD

The present invention relates to a method for detecting a memory access error in a multi-threaded application. Furthermore, the present invention relates to a computer program, an apparatus, and a storage medium for this purpose.

### BACKGROUND INFORMATION

Concurrency bugs in multi-threaded applications are a kind of memory access error and may particularly occur when at least two threads access and modify a memory access point of the application. These concurrency bugs, i.e., memory access errors, may be hard to reproduce and difficult to debug because triggering concurrency bugs may be timing dependent: threads may need to execute instructions in parallel in a particular order for the application to exhibit the deviant behaviour. Conventional dynamic data-race detectors may track accesses to shared resources to observe data races, i.e., multiple accesses to a given memory access point within a critical time span.

According to a dynamic approach in the related art, a lockset analysis may be used to deduce whether pairs of memory accesses share at least one mutually exclusive lock in common. According to another possible approach, memory accesses may be modified using special hardware support for code and data breakpoints to detect conflicting memory accesses. Other approaches have particularly explored modifying memory accesses at larger resource granularities (for example class objects) to do the same, with the help of programmer annotation to minimize overheads.

A focus in the state of the art is particularly on improving instrumentation overhead or accuracy and/or speed of exposing data-races, i.e., memory access errors, on a single machine. Edge architectures, that are becoming more popular in cyber-physical systems, may often run code across a large variety of hardware platforms with different performance characteristics that may not translate well from isolated testing. This may often be seen when data races, i.e., memory access errors, manifest when devices are upgraded and code is moved from a single to a multi-core processor.

As a result of lack of portability, prior solutions may often have resorted to running on-site or simulated testing on isolated test units. This may make the process slow, inaccurate as well as difficult or even technically not feasible to run on heterogeneous platforms.

Since instrumentation of every raw memory access may incur a high runtime overhead, most solutions particularly attempt to either instrument at higher levels of abstraction (class objects) or choose a subset of instructions to instrument. The drawbacks of these may be that the former offers less coverage and the latter may take a long time to find memory access errors.

### SUMMARY

According to aspects of the present invention, a method, a computer program, a data processing apparatus, and a computer-readable storage medium are provided. Features and details of the present invention are disclosed herein. Features and details described in the context to the inventive method also correspond to the inventive computer, the inventive data processing apparatus as well as the inventive computer-readable storage medium, and vice versa in each case.

According to an aspect of the present invention a method for detecting a memory access error in a multi-threaded application is provided. According to an example embodiment of the present invention, the method comprises the following steps:
Converting the multi-threaded application to a bytecode representation thereof,
Profiling the bytecode representation to determine at least one shared memory access point by at least two threads of the bytecode representation,
Injecting a delay time frame into a respective memory access operation to the shared memory access point by at least one thread of the at least two threads,
Monitoring accesses of the at least two threads to the shared memory access point during the delay time frame to detect the memory access error.

The memory access error may be a data race error, in which the at least two threads of the bytecode representation of the multi-threaded application try to modify a given memory access point within a critical time frame. This may lead to an unintentional deviant behaviour in the multi-threaded application. Thus, detecting the memory access error with the method according to the present invention may be advantageous to prevent such unintentional deviant behaviour due to memory access errors. Using the bytecode representation may be advantageous in that it may scale easily across heterogeneous devices and may offer low execution and memory overheads. The memory access point may be a variable that is used by both of the at least two threads. The delay time frame may be defined according to a specific use case or may be determined by trial and error. The monitoring of the accesses during the delay time frame may start after one of the at least two threads accesses the shared memory access point. In other words, the monitoring may imply that, after a first access by a thread, it is verified if another access by another thread occurs during the delay time frame. If this is the case, it may be concluded that the other access may cause the memory access error. It may further be specified, that the monitoring of the accesses only applies to accesses that modify the shared memory access point. It is possible that the delay time frame is varied at least once, particularly at least twice. After varying the delay time frame, the monitoring of the accesses may also be performed again accordingly to detect the memory access error based on at least two different delay time frames. The bytecode representation may thus be executed at least two times with respective delay time frames, wherein the monitoring of the accesses may accordingly also be performed at least two times to advantageously detect the memory access error based on at least two different delay time frames.

According to an example embodiment of the present invention, it is possible that the profiling comprises the following step:
Performing a static analysis of a source code of the bytecode representation to determine the at least one shared memory access point.

The static analysis may be advantageous in that any memory access point may be taken into account since the source code as a whole may be analysed.

According to an example embodiment of the present invention, it is further possible that the profiling comprises the following steps:
Modifying the bytecode representation to log memory accesses during an execution of the bytecode representation,
Identifying a respective memory access point as the at least one shared memory access point if said respective memory access point is accessed from at least two different threads of the bytecode representation during the execution.

The modifying may particularly be an instrumenting of the bytecode representation. Instrumenting the bytecode representation may refer to adding additional code which may allow for the logging of the memory accesses during the execution of the bytecode representation. The two steps described hereinabove may also be referred to as a dynamic analysis. The dynamic analysis may be advantageous in that it may be less time consuming to implement compared to analysing the whole source code. Furthermore, additional memory access errors may advantageously be detected by profiling the bytecode representation during the execution that may have not been detected in the static analysis.

In another example, at least during the monitoring of the accesses, the bytecode representation is executed on at least two different devices, the at least two different devices being different to one another by at least one performance characteristic. Executing the bytecode representation on at least two different devices may be advantageous in that characteristics of the different devices may be exposed that make it more or less likely for memory access errors to manifest. Furthermore, using two different devices instead of a single device may advantageously enhance a performance of detecting the memory access error. The at least one performance characteristic may be a processing power or a network performance. A device may in the context of the present invention be a processing node. It is also possible, that the bytecode representation is split into subsets of bytecode instructions and the subsets of bytecode instructions are profiled separately across the at least two different devices.

The modifying of the bytecode representation may be performed in accordance with the respective at least one performance characteristic of the at least two different devices. This may be advantageous in that time-critical applications may not be unduly impaired by the additional instrumentation.

In another example, the profiling further comprises the following steps:
Sampling at least one random subset of instructions of the bytecode representation,
Executing the bytecode representation based on the sampled at least one random subset of instructions.

This may be advantageous in that only a smaller number of instructions needs to be profiled compared to the whole multi-threaded application which may improve the performance of the method. It may be advantageous to execute a respective random subset on a respective device. The random subsets may vary across different devices that may be used.

In another example, the method further comprises the following step:
Eliminating at least one memory access operation, particularly all memory access operations, of the bytecode representation that is not accessing the at least one determined shared memory access point.

The term eliminating may describe that a respective memory access operation is deleted or disregarded and thus not executed by the bytecode representation. This may be advantageous in that less instructions have to be executed to profile the bytecode representation and/or to detect the memory access error which may reduce a required processing power.

According to an example embodiment of the present invention, the method may further comprise the following step:

Initiating an alert if the memory access error was detected.

This may be advantageous in that a user is notified and may initiate an appropriate countermeasure accordingly.

In another aspect of the present invention, a computer program may be provided, in particular a computer program product, comprising instructions which, when the computer program is executed by a computer, cause the computer to carry out the method according to the present invention. Thus, the computer program according to the present invention can have the same advantages as have been described in detail with reference to a method according to the present invention.

In another aspect of the present invention, an apparatus for data processing may be provided, which is configured to execute the method according to the present invention. As the apparatus, for example, a computer can be provided which executes the computer program according to the present invention. The computer may include at least one processor that can be used to execute the computer program. Also, a non-volatile data memory may be provided in which the computer program may be stored and from which the computer program may be read by the processor for being carried out.

According to another aspect of the present invention, a computer-readable storage medium may be provided which comprises the computer program according to the present invention and/or instructions which, when executed by a computer, cause the computer to carry out the steps of the method according to the present invention. The storage medium may be formed as a data storage device such as a hard disk and/or a non-volatile memory and/or a memory card and/or a solid state drive. The storage medium may, for example, be integrated into the computer.

Furthermore, the method according to the present invention may be implemented as a computer-implemented method.

Further advantages, features and details of the present invention will be apparent from the following description, in which example embodiments of the present invention are described in detail with reference to the figures. In this context, the features disclosed herein may each be essential to the present invention individually or in any combination.

### BRIEF DESCRIPTION OF THE DRAWINGS

FIG. 1 shows a method, computer program, a storage medium and apparatus according to embodiments of the present invention.

FIG. 2 shows an architecture for a framework for detecting memory access errors according to embodiments of the present invention.

### DETAILED DESCRIPTION OF EXAMPLE EMBODIMENTS

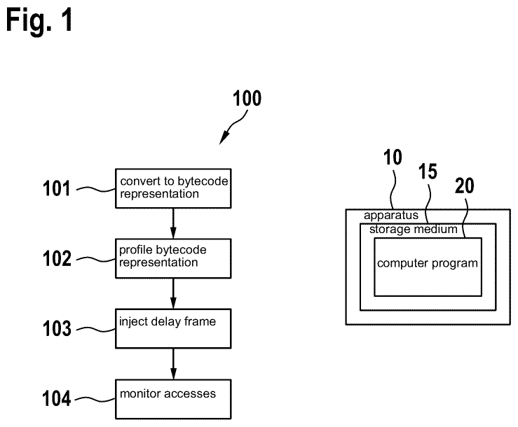

FIG. 1 shows a method 100, a computer program 20, a storage medium 15 and an apparatus 10 according to embodiments of the present invention.

The method 100 for detecting a memory access error 8 in a multi-threaded application according to the embodiment shown in FIG. 1 comprises the following steps. In a first step 101, the multi-threaded application is converted to a bytecode representation 3 thereof. In a second step 102, the bytecode representation 3 is profiled to determine at least one shared memory access point by at least two threads 4 of the bytecode representation 3. In a third step 103 a delay time frame is injected into a respective memory access operation to the shared memory access point by at least one thread 4 of the at least two threads 4. In a fourth step 104, accesses of the at least two threads 4 to the shared memory access point are monitored during the delay time frame to detect the memory access error 8.

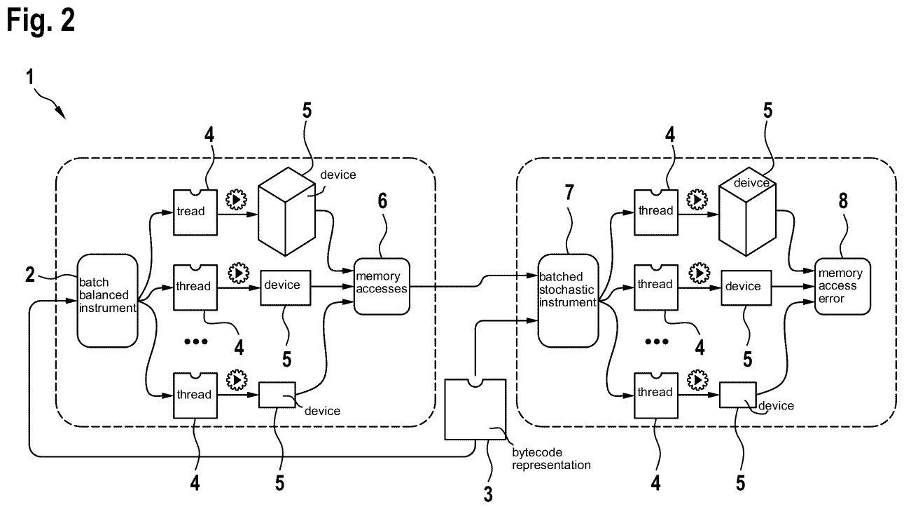

FIG. 2 shows an architecture 1 for a framework for detecting memory access errors 8 according to embodiments of the present invention. On the left side of FIG. 2, the profiling step 102 according to an embodiment is depicted. The bytecode representation 3 may be an input to a batched balanced instrument 2. Further, multiple threads 4 of the application may be executed on different devices 5 to detect conflicting memory accesses 6, i.e. shared memory access points. The conflicting memory accesses 6 and the bytecode representation 3 may then be an input to a batched stochastic instrument 7 to perform the detection step 103 according to an embodiment. Again, multiple threads 4 may be executed on the different devices 5 to then detect the memory access error 8.

According to example embodiments of the present invention, an intermediate code representation (IR), i.e., a bytecode representation 3, is used, preferably WebAssembly. As a language and platform agnostic compilation target, an intermediate code representation, preferably WebAssembly, may scale easily across heterogeneous devices and may offer very low execution and memory overheads. Using WebAssembly as an intermediate code representation, i.e. a bytecode representation 3, may provide a condensed and portable instruction set to work with, allowing for easy instrumentation.

The approach may also apply to any number of bytecode-based virtual execution environments like Java, WebAssembly, LUA, Python. WebAssembly may be preferable since it may support many different programming languages, execute at near-native speed and its semantics may formally be defined to remove non-deterministic execution, making this process even more effective.

One insight in the method according to example embodiments of the present invention may be that increased timing variability may be likely to produce more memory access errors 8. That is to say, probing all possible memory access points in the code may not be necessarily optimal at finding memory access errors 8 since probing in itself may limit the range of timing variability. As a result, two approaches are described hereinbelow that may explore timing characteristics of a multi-threaded application—platform heterogeneity and stochastic instrumentation. A combination of these two may also allow for fine-grained memory access tracking while not incurring the same overhead as previous approaches mentioned.

By running across a large range of heterogeneous devices 5 in parallel, more memory access errors 8, i.e., data races, may be detected quicker than by running a single device 5. This may also expose characteristics of devices 5 that make it more or less likely for such bugs, i.e., memory access errors, to manifest. Additionally, for timing-critical applications that require performance thresholds for functional correctness, the portability and amount of instrumentation may be tuned to match a devices' 5 performance characteristics. Faster devices 5 may instrument more, while slower ones like resource constrained microcontrollers, which are often difficult to profile and debug, may run a targeted subset of instrumentation points. Memory access, i.e., data race, errors 8 may be effectively detected by the method according to embodiments of the present invention by scaling out the detection process using a bytecode representation 3, preferably WebAssembly, as a base format.

Instrumentation of WebAssembly binary may be used, allowing the approach to work on Ahead of Time (AoT), Interpreted, or Just-in-Time (JIT) execution tier across multiple platforms.

The method according to embodiments of the present invention may comprise the following two phases. A profiling phase may be used to enable pruning of irrelevant memory accesses that can never cause data races and a violation detection phase may be used to detect concurrent accesses to a memory locations.

Since the method according to example embodiments of the present invention works at the bytecode representation level of abstraction, it may be assumed that the source code from any supported language may be compiled to a multi-threaded application, particularly a WebAssembly module.

Typically, a certain number of memory accesses may not cause race conditions like those to thread-local variables and unreferenced function locals on the stack. It may be advantageous to prune these out to reduce overheads when running the violation detection. Offline methods at doing this may not be effective, even for programs with static memory allocation, due to runtime function pointers and pointer aliasing. Runtime profiling may be performed by instrumenting the code at every memory access operation to call into custom WebAssembly host functions and log accesses to memory regions as they occur. If accesses are observed from at least two different thread IDs, the address may be marked as conflicting memory accesses 6, with a potential for conflict. Once profiling is done for a certain period of time, a reduced subset of memory accesses may be provided to instrument for the next phase. This analysis may be quite slow, especially if performed naively on a single device 5. Thus, map-reduce techniques may be employed to speed it up. One approach may be to sample random subsets of instructions, profile subsets in parallel on a distributed cluster of devices 5, and obtain the union of all pieces. This method may also work if non-deterministic mallocs and thread spawning is present in the code, but may require a large scale-out for good coverage since a given pair to be sampled together may be needed in at least one instance. However, for deterministic programs, a memory determinism of the bytecode representation, particularly WebAssembly's memory determinism, may be leveraged to ensure that a given instruction accesses the same memory address, i.e. memory access point, across all runs in any device 5. As a result, disjoint sets may be instrumented in parallel and a merge may be performed with the assumption that the memory accesses and thread ID are consistent between devices 5. Additionally, to improve average overhead, not just random disjoint partitions may be observed but instead “balanced execution partitions” such that each device 5 may receive an equal number of instrumentation points in every block/loop scope. This may prevent one device 5 from running heavily instrumented hot loops and bottle-necking the algorithm. This may be run across heterogeneous devices 5 for more code coverage as well.

After obtaining the conflicting memory accesses, only those accesses may be instrumented for the memory access error 8, i.e., data race, detection phase. An algorithm may be envisioned in the instrumented code, where trap is set, a delay is injected into the instrumentation, and the trap is cleared. If another access occurs at this address, i.e., memory access point, during this delay and either access is a write, the violation, i.e., the memory access error 8, may be detected and the pair of accesses may be recorded.

One divergent approach may be to start by assuming every instrumentation point may cause a memory access error 8. This may make it more likely to capture infrequent code paths. The prior profiling step may also already prune safe accesses, making this step rather unnecessary. Given this algorithm, more memory access errors 8 may be detected by increasing timing variability. A similar map-reduce approach may be performed as described above. Thus, stochastic subsets of these memory access points may be instrumented, and the detection of the memory access error 8 may be run in parallel on distributed devices 5. Detected violations, i.e. memory access errors 8, from each device 5 may finally be merged and deduped to produce a final set of violations, i.e. memory access errors 8, across the cluster.

The above explanation of the embodiments describes the present invention in the context of examples. Of course, individual features of the embodiments can be freely combined with each other, provided that this is technically reasonable, without leaving the scope of the present invention.

What is claimed is:

1. A method for detecting a memory access error in a multi-threaded application, comprising the following steps:
converting the multi-threaded application to a bytecode representation of the multi-threaded application;
profiling the bytecode representation to determine at least one shared memory access point by at least two threads of the bytecode representation;
injecting a delay time frame into a respective memory access operation to the shared memory access point by at least one thread of the at least two threads;
monitoring accesses of the at least two threads to the shared memory access point during the delay time frame to detect the memory access error.

2. The method of claim 1, wherein the profiling includes the following step:
performing a static analysis of a source code of the bytecode representation to determine the at least one shared memory access point.

3. The method of claim 1, wherein the profiling includes the following steps:
modifying the bytecode representation to log memory accesses during an execution of the bytecode representation; and
identifying a respective memory access point as the at least one shared memory access point when the respective memory access point is accessed from at least two different threads of the bytecode representation during the execution.

4. The method of claim 3, wherein, at least during the monitoring, the bytecode representation is executed on at least two different devices, the at least two different devices being different to one another by at least one performance characteristic.

5. The method of claim 4, wherein the modifying of the bytecode representation is performed in accordance with the respective at least one performance characteristic of the at least two different devices.

6. The method of claim 3, wherein the profiling further includes the following steps:
sampling at least one random subset of instructions of the bytecode representation;
executing the bytecode representation based on the sampled at least one random subset of instructions.

7. The method of claim 1, wherein the method further comprises the following step:
eliminating at least one memory access operation of the bytecode representation that is not accessing the at least one determined shared memory access point.

8. A data processing apparatus configured to detect a memory access error in a multi-threaded application, the device configured to:
convert the multi-threaded application to a bytecode representation of the multi-threaded application;
profile the bytecode representation to determine at least one shared memory access point by at least two threads of the bytecode representation;
inject a delay time frame into a respective memory access operation to the shared memory access point by at least one thread of the at least two threads;
monitor accesses of the at least two threads to the shared memory access point during the delay time frame to detect the memory access error.

9. A non-transitory computer-readable storage medium on which are stored instructions for detecting a memory access error in a multi-threaded application, the instructions, when executed by a computer, causing the computer to perform the following steps:
converting the multi-threaded application to a bytecode representation of the multi-threaded application;
profiling the bytecode representation to determine at least one shared memory access point by at least two threads of the bytecode representation;
injecting a delay time frame into a respective memory access operation to the shared memory access point by at least one thread of the at least two threads;
monitoring accesses of the at least two threads to the shared memory access point during the delay time frame to detect the memory access error.
